(19) United States
(12) Patent Application Publication
(10) Pub. No.: US 2025/0288096 A1
(43) Pub. Date: Sep. 18, 2025

(54) TRAVERSE FOR A SHELF WITH RECEIVING ELEMENTS FOR PANELS

(71) Applicant: BITO-LAGERTECHNIK BITTMANN GMBH, Meisenheim (DE)

(72) Inventor: Dennis Juergen MARTINI, Staudernheim (DE)

(21) Appl. No.: 19/072,464

(22) Filed: Mar. 6, 2025

(30) Foreign Application Priority Data
Mar. 12, 2024 (DE) 10 2024 107 067.6

(51) Int. Cl. A47B 47/00

(52) U.S. Cl. CPC A47B 47/00

(57) ABSTRACT

The invention relates to a traverse (1) for a shelf (10) for supporting at least one panel (2) of the shelf (10), wherein the traverse (1) has a side surface (4) running parallel to the longitudinal axis (3) of the traverse (1) and at least one receiving element (5) for fastening the panel (2), and the receiving element (5) is arranged on the side surface (4) and has a section (6) which is at a distance (7) from the side surface (4) and extends to a free-standing end (8) of the receiving element (5), and the receiving element (5) is integrally formed out of a material of the traverse (1).

### CROSS REFERENCE TO RELATED APPLICATION

The present application claims priority to German Patent Application Serial No. 10 2024 107 067.6 filed Mar. 12, 2024, entitled TRAVERSE FOR A SHELF WITH RECEIVING ELEMENTS FOR PANELS, the entire contents of which are incorporated herein by reference.

### FIELD OF THE INVENTION

The invention relates to a traverse for a shelf as well as a shelf with a traverse and at least one panel.

### BACKGROUND

Many types of shelves are known from the prior art. For example, the European patent application EP 0273345 A2 discloses a shelf, in particular a panel shelf, having longitudinal and/or transverse beams as supporting elements hooked in and/or fastened between upright shelf posts.

WO 00/27733 A1 discloses a shelf with panels, whereby the panels can be inserted into recesses of traverses. Here, claws of the traverses engage in lateral recesses of the panels. WO 201010/022448 A1 discloses a shelving system with panels that can be inserted from above into recesses in traverses.

In EP 2 392 230 B1, a shelf with a shelf panel having one horizontal and two vertical legs is described, with the horizontal leg having a recess, wherein the recess extends completely to the end of the vertical side of the panel in the direction of extension of the panel, wherein at the edge of the recess, the horizontal leg is inclined pointing away from the end of the panel in the direction of the area between the vertical legs.

In U.S. Pat. No. 5,310,066A a cantilever shelf with support columns, traverses and panels is described. A rear and a front traverse are mounted on the support columns, with the front traverses having holders for the panels. The holders are U-shaped and made from a material of the front traverses.

### SUMMARY OF THE INVENTION

The problem underlying the invention is to provide a traverse for a shelf and a shelf with a traverse. The problems underlying the invention are solved by the features of the independent patent claim. Preferred embodiments of the invention are given in the dependent patent claims.

A traverse for a shelf for supporting at least one panel of the shelf is proposed. The traverse has a side surface running parallel to the longitudinal axis of the traverse and at least one receiving element for fastening the panel. The receiving element is arranged on the side surface and has a section. The section is at a distance from the side surface and extends up to a free-standing end of the receiving element. The section can run parallel or at an angle to the side surface. Furthermore, the receiving element is integrally formed out of a material of the traverse.

In a state of the traverse being installed in the shelf, the longitudinal axis of the traverse runs, for example, in a horizontal first plane of the shelf, with the side surface of the traverse preferably running perpendicular to the first plane. The section of the receiving element having the distance to the side surface results in a space for inserting a fastening element of the panel for fastening the panel to the receiving element. The fastening element can be inserted from top to bottom in a vertical direction into the space between the receiving element and the side surface. According to the invention, the receiving element is integrally formed out of the material of the traverse. An integral forming of the receiving element out of the material of the traverse can exemplarily be implemented by pressing, in particular by punching.

Integral forming is in this case to be understood in particular as meaning that the receiving element was part of the side surface before the integral forming. The material of the traverse thus corresponds to the material of the receiving element and the receiving element is still partially connected to the traverse. It is possible, for example, that the receiving element has been bent out of the side surface of the traverse by a mechanical process and, for example, has thus been partially separated from the side surface. The integral forming of the receiving element may further comprise any one of a deforming, shear-bending, shaping out, stamping out, or partial cutting and pressing out of the material of the side surface of the traverse.

Due to the fact that the receiving element is integrally formed out of the material of the traverse, the receiving element does not have to be mounted on the side surface with the aid of additional fastening means. As a result, on the one hand material and on the other hand a mounting step, namely a mounting of the receiving element on the side surface, can be dispensed with. Due to the free-standing end of the receiving element, a warping of the material of the traverse on the side surface during the integral forming can be reduced. In particular, the free-standing end can reduce any stress peaks which can arise in the material of the traverse as a result of the integral forming. The risk of any material weakening is thereby minimized and the overall stability of the traverse can be maximized.

In an advantageous embodiment, the receiving element has a recess which runs in a direction substantially perpendicular to the longitudinal axis and that is open at the top for receiving the panel in the perpendicular direction. The recess which is open at the top permits receiving a leg of the panel, which faces downwards in the mounted state of the panel into the recess, in such a way that one end of the panel comes into engagement with the receiving element. In particular, edges of the recess can block a movement of the panel when the panel is inserted into the receiving element. In this case, the panel can no longer “slip” laterally, i.e. in the direction of the longitudinal axis of the traverse.

According to a development, it is intended that two of the receiving elements are arranged on the side surface, wherein the free-standing ends of the two receiving elements lie in a second plane which runs parallel to the side surface. The free-standing ends of the two receiving elements have a distance from one another within the second plane. As a result of the two receiving elements lying within the second plane, the end of the panel can be inserted into both receiving elements at the same time. The two receiving elements ensure a more secure fastening of the end of the panel to the traverse in comparison with a fastening of the end with just one receiving element. In particular, the two receiving elements together can block a movement of the panel and minimize the risk of tilting of the panel about the longitudinal axis thereof in the case of unfavorable loading.

The panel can be fastened even more securely to the two receiving elements when the two receiving elements each have the recess. The panel, in particular the end of the panel which is to be fastened to the traverse, here advantageously has a U-shaped cross section. The U-shaped cross section is formed by two legs which face downwards in the installed state of the panel and a horizontal leg which connects the two downward-facing legs. The two downward-facing legs can be inserted into the two recesses or be received by the latter during when fastening the panel to the traverse.

A particularly advantageous embodiment provides that the recesses of the two receiving elements each have edges which are facing one another and that these edges are inclined with respect to one another. This allows the legs of the U-shaped end of the panel to be pushed together or apart when the panel is inserted into the recesses, creating contact pressure between the edges and the downward-facing legs. This contact pressure can produce a secure hold of the end of the panel in the recesses. The edges of the recesses are advantageously formed in such a way that they form a respective detent nose in the lower region of the recesses, in which a respective recess of the downward-facing leg of the panel can latch.

According to a further embodiment, the traverse has an breakthrough (a hole so to speak) which is formed by the integral forming of the receiving element out of the material of the traverse. As a result of the breakthrough being present on account of the integral forming of the receiving element, the traverse has a strap above the breakthrough, which increases a stability of the traverse in a region around the receiving element. This embodiment represents in particular an improvement over a variant in which the panel is pushed into a recess which is worked into the side surface directly from above. The strap which is now created in the proposed traverse by the integral forming of the receiving element reduces a deformation of the traverse when the panel is loaded in the installed state.

In a further embodiment, two of the receiving elements are arranged on the side surface (in particular as described above), wherein the traverse has two of the breakthroughs. The two breakthroughs have a distance from one another, with the result that a bridge is formed between the breakthroughs. The bridge stabilizes in particular the strap of the traverse which extends over the bridge. This can furthermore increase the stability of the traverse.

In a particular embodiment, the traverse has at least one corner area at which a side edge of the receiving element directly adjoins the side surface and beginning at which the receiving element is integrally formed out of the material of the traverse or of the side surface (it could also be said at which or via which the receiving element is connected to the side surface). In this embodiment, the traverse has a relief recess in the corner area in addition to the recess of the side surface which results from the integral forming, that is to say in addition to the breakthrough. The side edge of the receiving element leads in particular from the free-standing end to the side surface, wherein the side edge butts against the side surface. In particular, the receiving element, in particular the side edge, begins in the corner area.

In particular, the corner area is understood to be an area around the beginning of the side edge, which also includes parts of the side surface that are at a distance from the side edge. surface The relief recess can in particular reduce a notch effect which can arise in the case of a vertically acting load on the receiving element. Furthermore, the relief recess can reduce notch stresses which can arise during the integral forming of the receiving element out of the material of the traverse.

According to a possible embodiment, the relief recess can have a round shape. In a simple case, the relief recess is configured in the form of a bore. In a further embodiment, the relief recess can have, in a cross section which runs parallel to the side surface, a spoon shape with an elongate slot and a round end which adjoins the slot. In this embodiment, the slot adjoins the corner area and extends away from the corner area and the free-standing end of the receiving element. The elongate slot has the effect that a formation of a notch during the integral forming, which can cause extremely high stresses in the normal case during the integral forming of the receiving element, can be avoided. The relief recess is advantageously produced before the integral forming. The relief recess is preferably worked into the traverse by punching with a tool which has the cross-sectional shape of the relief recess.

Furthermore, a shelf with a traverse and at least one panel is proposed. The traverse can be configured according to one of the abovementioned variants. The traverse has at least a side surface which runs parallel to the longitudinal axis of the traverse and at least one receiving element for fastening the panel. The receiving element is arranged on the side surface and has a section. The section is at a distance from the side surface and extends as far as a free-standing end of the receiving element. Furthermore, the receiving element is integrally formed out of a material of the traverse.

### BRIEF DESCRIPTION OF THE DRAWINGS

Exemplary embodiments of the proposed traverse are explained in more detail with reference to the following figures. Herein shown schematically is:

FIG. 1 a shelf with a traverse and panels;

FIG. 2 a first perspective view of the traverse shown in FIG. 1 with two receiving elements for fastening a panel of the shelf;

FIG. 3 a top view of a side wall of the traverse shown in FIG. 1;

FIG. 4 a perspective view of the two receiving elements shown in FIG. 2;

FIG. 5 a variant of the panel shown in FIG. 1;

FIG. 6 a further possible arrangement of the two receiving elements shown in FIG. 2 with respect to one another;

FIG. 7 the traverse shown in FIG. 1 with receiving elements in addition to those shown in FIGS. 3 and 4.

### DETAILED DESCRIPTION

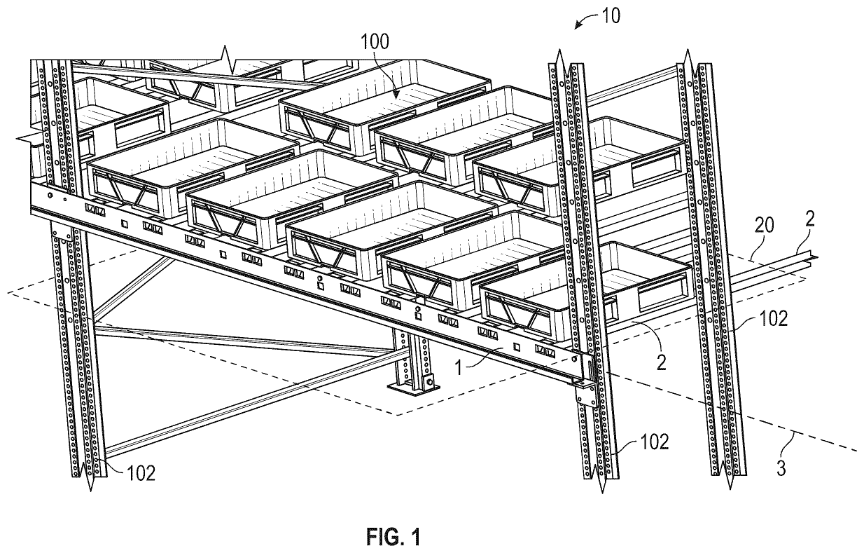

FIG. 1 shows a shelf 10 with a traverse 1. The traverse 1 has a longitudinal axis 3 which runs parallel to a first plane 20. The shelf 10 has at least one further traverse which is not shown in FIG. 1 for the sake of clarity. The further traverse is arranged within the plane 20 opposite the traverse 1 and runs parallel to the traverse 1. Panels which run parallel to the first plane 20, including a panel 2, are fastened to the traverse 1 and to the further traverse. The traverse 1, preferably also the further traverse, is fastened to vertical shelf supports 102 of the shelf 10. As can be seen from FIG. 1, the panels, in particular the panel 2, run perpendicularly to the traverse 1 within the first plane 20. For example, a plurality of containers 100 can be stored with the aid of the shelf 10.

FIG. 2 shows a perspective view of the traverse 1. The traverse 1 has a side surface 4 which runs parallel to the longitudinal axis 3 and at least one receiving element 5 for fastening the panel 2. The receiving element 5 is arranged on the side surface 4 and has a section 6. The section 6 is at a first distance 7 from the side surface 4 and extends as far as a free-standing end 8 of the receiving element 5. In the variant shown in FIG. 2, the section 6 runs parallel to the side surface 4. The first distance 7 can be, for example, 5 to 15 mm, preferably 8 mm. According to the invention, the receiving element 5 is integrally formed out of a material of the traverse 1. In particular, the receiving element 5 is created by pressing and punching a first tool which is placed on a further side surface of the traverse 1 which lies opposite the side surface 4. The first tool can be pressed or punched through the traverse 1, in particular in a direction which runs perpendicularly to the longitudinal axis 3, in order to form the receiving element 5 out of the material of the traverse 1.

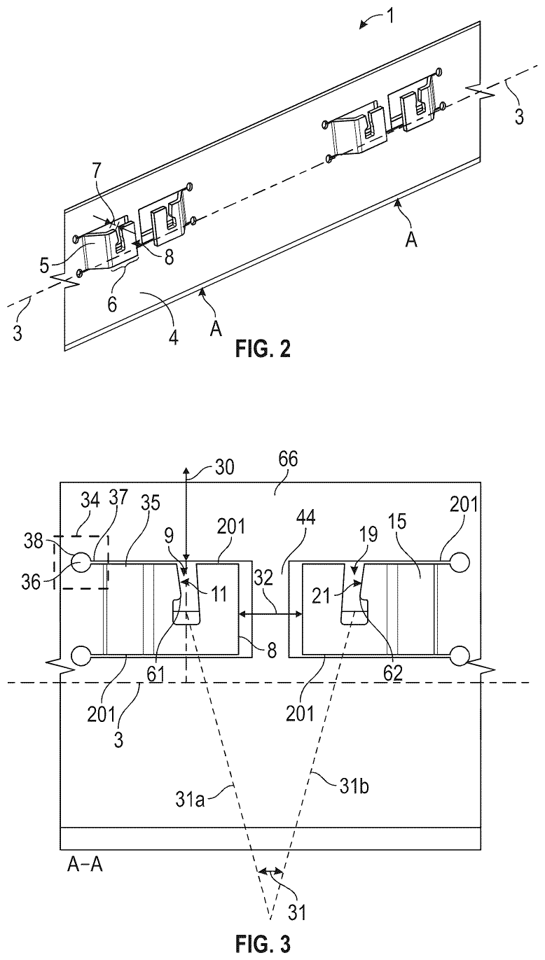

FIG. 3 shows the traverse 1 in a projected view in a viewing direction A-A shown in FIG. 2. In the variant shown in FIGS. 2 and 3, the receiving element 5 has a recess 9 which runs substantially perpendicularly to the longitudinal axis 3 and that is open at the top. A direction 30 which is oriented exactly perpendicularly to the longitudinal axis is shown in FIG. 3 and runs vertically in space when the shelf 10 is set up. The recess 9 which is open at the top serves for receiving the panel 2 in the direction 30, wherein here the panel 2 is moved from top to bottom in the direction 30 in order to place an end of the panel 2 in the recess 9. The recess 9 which runs substantially in the direction 30 can also assume an angle of approximately 10 degrees to the direction 30, as shown in FIG. 3.

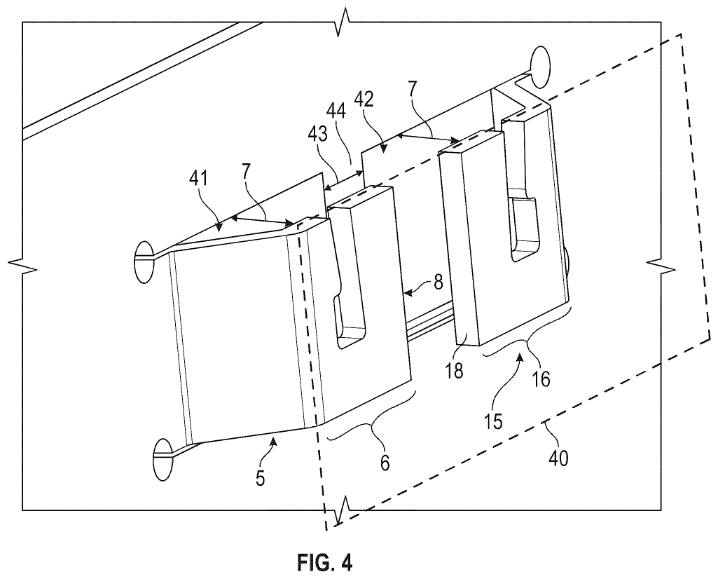

In the variant of the traverse 1 shown according to FIGS. 2 and 3, two receiving elements, namely the receiving element 5 and a further receiving element 15, are arranged on the side surface 4. The further receiving element 15 has, analogously to the receiving element 5, a free-standing end 18 shown in FIG. 4. The further receiving element 15 likewise has a section 16 which runs parallel to the side surface 4 and which is at the first distance 7 from the side surface 4. Analogously, the section 16 extends up to the free end 18.

The free-standing ends 8, 18 of the two receiving elements 5, 15 lie in a second plane 40 which runs parallel to the side surface and has the first distance 7 from the side surface. Within the second plane 40, the free-standing ends 8, 18 have a second distance 32, as shown in FIG. 3. The second distance 32 can be, for example, 1 to 2 cm.

FIG. 3 furthermore shows that the further receiving element 15 likewise has a recess 19. In the variant of the receiving elements 5, 15 shown in the figures, edges 11, 21 of the recesses 9, 19 of the two receiving elements 5, 15 which are facing one another are inclined with respect to one another. This is shown concretely by an angle 31, the first leg 31a of which is configured in the form of an extension of a first edge 11 of the recess 9 and the second leg 31b of which is configured in the form of an extension of a first edge 21 of the recess 19. The angle 31 can be, for example, 20 to 25 degrees, advantageously 23 degrees.

As shown in the figures, the traverse 1 has a breakthrough 41 shown in FIG. 4, which is created by the integral forming of the receiving element 5 out of the material of the traverse 1. Furthermore, in the variants shown in the figures, the traverse 1 has a second breakthrough 42, which is created by the integral forming of the further receiving element 15 out of the material of the traverse 1. The first breakthrough 41 is at a third distance 43 to the second breakthrough 42. By the third distance 43 a bridge 44 is created which extends between the breakthroughs 41, 42 in the vertical direction parallel to the second plane 40.

FIG. 3 furthermore shows that the traverse 1 has at least one first corner area 34 at which a first side edge 35 of the receiving element 5 directly adjoins the side surface 4. In particular, the receiving element 5 is integrally formed out of the material of the traverse 1 beginning at the corner area 34. The traverse 1 has a relief recess 36 in the corner area 34. The relief recess 36 can be understood as an additional recess in addition to the first breakthrough 41.

The relief recess 36 advantageously has a round shape and can be configured as a bore. The bore advantageously has a diameter of more than 5 mm. In particular, the relief recess 36 has, in a cross section which extends parallel to the side wall 4 in the material of the traverse 1, a spoon shape with an elongate slot 37 and a round end 38 which adjoins the slot 37. The slot 37 adjoins the corner area 34 and extends away from the free-standing end 8.

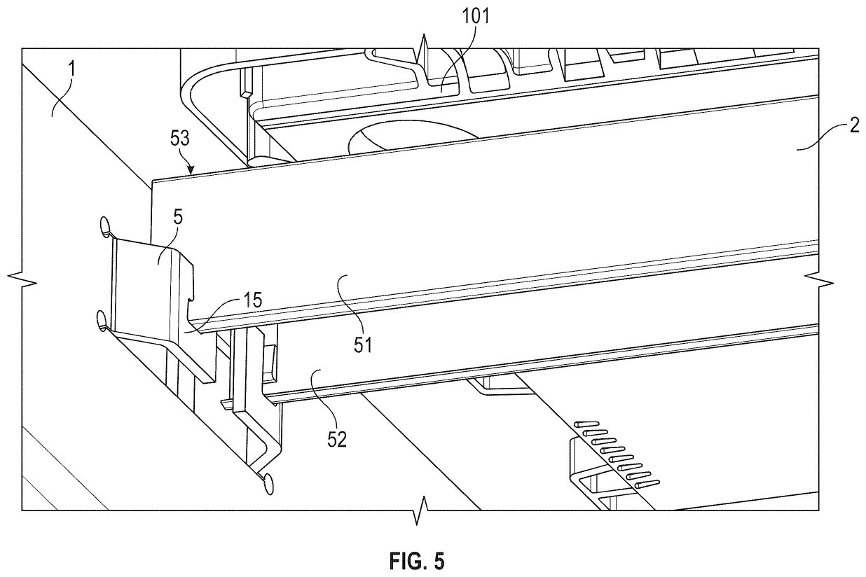

FIG. 5 shows a possible embodiment of the panel 2 in a perspective view obliquely from below. In this embodiment, the panel 2 is configured in the form of a U-shaped profile. The U-shaped profile is formed here by a first leg 51 and a second leg 52 of the panel 2 which are connected to one another by a horizontal leg (not shown in FIG. 5) of the panel 2. The first and the second leg 51, 52 run parallel to one another from top to bottom when the panel 2 is fastened to the traverse 1. Furthermore, FIG. 5 shows a container 101 of the container 100 shown in FIG. 1 from below. The container 101 lies on an upper side of the panel 2.

In order to fasten a first end 53 of the panel 2 to the traverse 1, the first end 53 is pushed from top to bottom in a direction 30 into the two receiving elements 5, 15. Here the edges 11, 21 of the two receiving elements 5, 15 serve as guide edges. As a result of the two edges 11, 21 being inclined with respect to one another, the two legs 51, 52 are pressed together during a movement of the first end 53 from top to bottom into the receiving elements 5, 15. Through this a force arises which presses the two legs 51, 52 apart after a respective opening of the first leg 51 and of the second leg 52 has passed a detent nose 61 of the receiving element 5 or a detent nose 62 of the further receiving element 15. A pressing apart of the two legs 51, 52 has the effect that the legs 51, 52 spring back into their original shape, as a result of which a secure fit of the first end 53 of the panel 2 in the receiving elements 5, 15 is ensured. The detent noses 61, 62 result from a corresponding course of the edges 11, 21 of the receiving elements 5, 15.

As a result of the free-standing ends 8, 18 being at the second distance 32 from one another and in particular being free in space in relation to the side surface 4, a following interaction between the receiving elements 5, 15 and the legs 51, 52 of the panel 2 results during the insertion of the panel 2 into the receiving elements 5, 15. As a result of the ends 8, 18 being free and not being connected to one another as in a U-shaped holder, as is described, for example, in the abovementioned U.S. Pat. No. 5,310,066A, the receiving elements 5, 15 can move away from one another within the second plane 40 during the pressing-down of the legs 51, 52 along the edges 11, 21. This makes it possible that This allows to bring about a latching of the openings of the legs 51, 52 into the detent noses 61, 62 without needing the two legs 51, 52 to be pressed together as strongly. This enables the panel 2 to be configured more rigidly, as a result of which a higher load-bearing capacity of the panel 2 is made possible.

For example, a wall thickness of the legs 51, 52, and in particular of the horizontal leg, can be dimensioned to be higher. If, on the other hand, the panel 2 is not dimensioned to be stronger, an easier insertion of the first end 53 into the receiving elements 5, 15 results as a result of the free-standing ends 8, 18 moving apart. This is due to the fact that a common spring stiffness which acts during the pressing-down of the legs 51, 52 along the edges 11, 21 and results from an elastic behavior of the legs 51, 52 and an elastic behavior of the receiving elements 5, 15 together is lower than a spring stiffness which results solely from the elastic behavior of the two legs 51, 52. An easier insertion of the panel 2 into the receiving elements 5, 15 of course facilitates the mounting of the panels of the shelf 10.

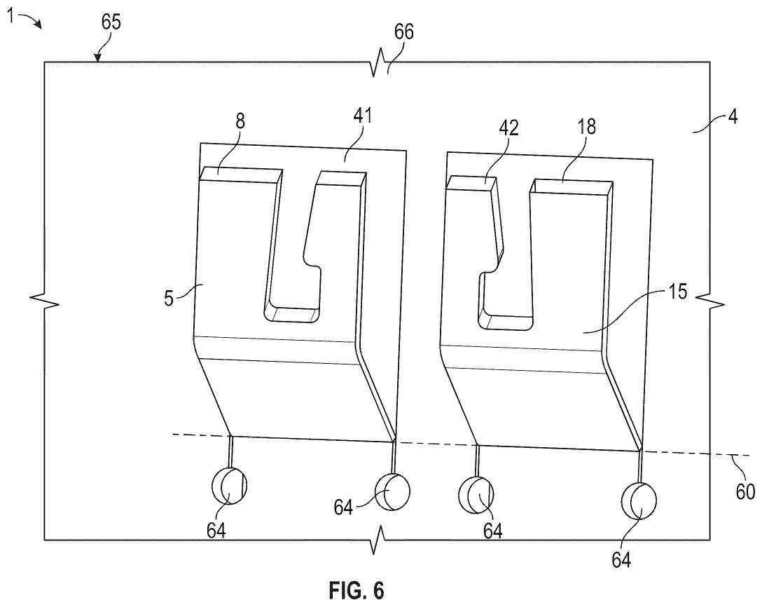

FIG. 6 shows a further variant of the traverse 1, in which the free-standing ends 8, 18 of the two receiving elements 5, 15 are not facing one another as shown in FIGS. 2 to 5, but rather point in the same direction, for example upwards, as shown in FIG. 6. The two breakthroughs 41, 42 are arranged at a distance from one another as in the variant shown in FIGS. 1 to 5. However, the two receiving elements 5, 15 are integrally formed out of the material of the traverse 1 in a way resulting in a common height line 60 beginning at which the two receiving elements 5, 15 are formed out of the material of the traverse 1. This can have the advantage, for example, that multiple relief bores 64 can be produced more easily since they lie next to one another at the same height which runs parallel to the common height 60.

Furthermore, in the variant shown in FIG. 6, the relief bores 64 have a greater distance from an upper edge 65 of the traverse 1. Under certain circumstances, this can bring about a higher stability of a strap 66 which is produced during the integral forming of the receiving elements 5, 15 in the upper region of the traverse 1. A possible weakening of the material of the traverse 1 which can arise during the integral forming of the receiving elements 5, 15 can also be displaced into a region which has a greater distance from the strap 66 than in the variant of the traverse 1 shown in FIGS. 1 to 5.

Furthermore, in the variant shown in FIG. 6, specifically in the case of higher loads by panel 2, better load transfers into the traverse 1 arise since no shear forces occur, but rather pressure forces in the region of a transition between the receiving elements 5, 15 and the traverse 1.

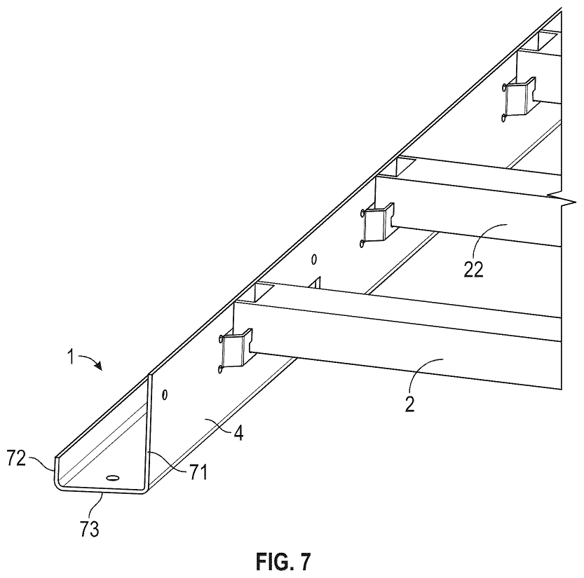

FIG. 7 shows a possible embodiment of the traverse 1 in the form of an asymmetrical U-profile. The U-profile is formed here by a first leg 71 and a second leg 72 which is configured to be shorter than the first leg 71, and a horizontal leg 73. The horizontal leg 73 connects the two legs 71, 72 to one another. The first leg 71 has the side surface 4 shown in FIGS. 1 to 6 and a further side surface concealed in FIG. 7. FIG. 7 shows how on the traverse 1 not only the panel 2 but a further panel 22 is fastened to the traverse 1. Here the further panel 22 is fastened to the traverse 1 analogously to the panel 2 with the aid of two further receiving elements which are configured analogously to the receiving elements 5, 15.

The horizontal leg 73 can in particular create a support surface for wheels of a storage and retrieval vehicle, such as for example a storage and retrieval shuttle. A lateral slipping of the wheels is prevented here by the two legs 71, 72, with the result that the U-profile forms a drive channel for the storage and retrieval vehicle. Here the traverse 1 bears at least part of a weight of the storage and retrieval vehicle. As a result of the panel 2 being supported with the aid of the receiving elements 5, 15 and not being received by a hypothetical slot of the traverse 1 which extends downwards from the upper edge 65, the traverse 1 is configured more stably in an upper region of the first leg 71, in particular in the region of the strap 66. As a result, significant material savings can be realized in the form of a lower material strength of the traverse 1 at unchanged loads which act on the panel 2 from the storage and retrieval shuttle or from a container.

The invention may be characterized by the features of the following clauses:
Clause 1: A traverse (1) for a shelf (10) for supporting at least one panel (2) of the shelf (10), wherein the traverse (1) has a side surface (4) running parallel to the longitudinal axis (3) of the traverse (1) and at least one receiving element (5) for fastening the panel (2), and the receiving element (5) is arranged on the side surface (4) and has a section (6) which is at a distance (7) from the side surface (4) and extends to a free-standing end (8) of the receiving element (5), and the receiving element (5) is integrally formed out of a material of the traverse (1).
Clause 2: The traverse (1) according to clause 1, wherein the receiving element (5) has a recess (9) running in a direction substantially vertical to the longitudinal axis (3) and that is open at the top for receiving the panel (2) in the vertical direction.
Clause 3: The traverse (1) according to clause 1 or 2, wherein two of the receiving elements (5, 15) are arranged on the side surface (4), wherein the free-standing ends (8, 18) of the two receiving elements (5, 15) lie in a plane (40) that runs parallel to the side surface (4) and are at a distance (32) from one another within the plane (40).
Clause 4: The traverse (1) according to clause 2 and 3, wherein the two receiving elements (5, 15) each have the recess (9, 19), wherein edges (11, 21) of the recesses (9, 19) of the two receiving elements (5, 15) that face one another are inclined with respect to one another.
Clause 5: The traverse (1) according to one of the previous clauses, the traverse (1) having a breakthrough (41) which is created by the integral forming of the receiving element (5) out of the material of the traverse (1).
Clause 6: The traverse (1) according to clause 5, wherein two of the receiving elements (5, 15) are arranged on the side surface (4), the traverse (1) having two of the breakthroughs (41, 42), the two breakthroughs (41, 42) being at a distance (43) from one another, so that a bridge (44) is formed between the breakthroughs (41, 42).
Clause 7: The traverse (1) according to one of the previous clauses, further having at least one corner area (34), at which a side edge (35) of the receiving element (5) directly adjoins the side surface (4) and beginning at which the receiving element (5) is integrally formed out of the material of the traverse (1), wherein the traverse (1) has a relief recess (36) in the corner area (34) in addition to the recess of the side surface (4) resulting from the integral forming.
Clause 8: The traverse (1) according to clause 7, wherein the relief recess (36) has a round shape or has a spoon shape in a cross-section with an elongated slot (37) and a round end (38) adjacent to the slot (37), wherein the slot (37) adjoins the corner area (34) and extends away from the corner area (34) and the free-standing end (8).
Clause 9: A shelf (10) with at least one traverse (1) and at least one panel, wherein the traverse (1) has a side surface (4) running parallel to the longitudinal axis (3) of the traverse (1) and at least one receiving element (5) for fastening the panel (2), and the receiving element (5) is arranged on the side surface (4) and has a section (6) which is at a distance (7) from the side surface (4) and extends to a free-standing end (8) of the receiving element (5), and the receiving element (5) is integrally formed out of a material of the traverse (1).

### REFERENCE SIGNS LIST

1 traverse
2, 22 panel
3 longitudinal axis of the traverse
4 side surface of the traverse
5, 15 receiving element
6, 16 section of the receiving element
7 first distance
8, 18 free-standing end of the receiving element
9, 19 recess
10 shelf
11, 21 edge
20 first plane
30 direction
31 angle
31a first leg of the angle
31b second leg of the angle
32 second distance
34 corner area
35 side edge of the receiving element
36 relief recess
37 slot
38 round end
40 second plane
41, 42 breakthrough
43 third distance
44
51 bridge
52 first leg of the panel
53 second leg of the panel
60 first end of the panel
61, 62 common height line
61, 62 detent nose
64 relief bores 64
65 upper edge of the traverse
66 strap
71 first leg of the U-profile
72 second leg of the U-profile
73 horizontal leg of the U-profile
100, 101 container
102 shelf supports

1. A traverse for a shelf for supporting at least one panel of the shelf, wherein the traverse has a side surface running parallel to the longitudinal axis of the traverse and at least one receiving element for fastening the panel, and the receiving element is arranged on the side surface and has a section which is at a distance from the side surface and extends to a free-standing end of the receiving element, and the receiving element is integrally formed out of a material of the traverse.

2. The traverse according to claim 1, wherein the receiving element has a recess running in a direction substantially vertical to the longitudinal axis and that is open at the top for receiving the panel in the vertical direction.

3. The traverse according to claim 1, wherein two of the receiving elements are arranged on the side surface, wherein the free-standing ends of the two receiving elements lie in a plane that runs parallel to the side surface and are at a distance from one another within the plane.

4. The traverse according to claim 3, wherein the two receiving elements each have the recess, wherein edges of the recesses of the two receiving elements that face one another are inclined with respect to one another.

5. The traverse according to claim 1, the traverse having a breakthrough which is created by the integral forming of the receiving element out of the material of the traverse.

6. The traverse according to claim 5, wherein two of the receiving elements are arranged on the side surface, the traverse having two of the breakthroughs, the two breakthroughs being at a distance from one another, so that a bridge is formed between the breakthroughs.

7. The traverse according to claim 1, further having at least one corner area, at which a side edge of the receiving element directly adjoins the side surface and beginning at which the receiving element is integrally formed out of the material of the traverse, wherein the traverse has a relief recess in the corner area in addition to the recess of the side surface resulting from the integral forming.

8. The traverse according to claim 7, wherein the relief recess
has a round shape or
has a spoon shape in a cross-section with an elongated slot and a round end adjacent to the slot, wherein the slot adjoins the corner area and extends away from the corner area and the free-standing end.

9. A shelf with at least one traverse and at least one panel, wherein the traverse has a side surface running parallel to the longitudinal axis of the traverse and at least one receiving element for fastening the panel, and the receiving element is arranged on the side surface and has a section which is at a distance from the side surface and extends to a free-standing end of the receiving element, and the receiving element is integrally formed out of a material of the traverse.
